(19) United States
(12) Patent Application Publication
(10) Pub. No.: US 2010/0047390 A1
(43) Pub. Date: Feb. 25, 2010

(54) FERMENTED PRODUCTS CONTAINING DIETARY FIBERS AND METHODS FOR PREPARING THE SAME

(75) Inventors: Olivier Noble, Orsay (FR); Arnaud Lyothier, Anieres Sur Seine (FR)

Correspondence Address: YOUNG & THOMPSON, 209 Madison Street, Suite 500, Alexandria, VA, 22314, US

(73) Assignee: COMPAGNIE GERVAIS DANONE, Orsay (FR)

(21) Appl. No.: 12/516,238

(22) PCT Filed: Dec. 14, 2007
(86) PCT No.: PCT/FR2007/002078

§ 371 Date: Aug. 21, 2009

(30) Foreign Application Priority Data
Dec. 20, 2006 (FR) 0611132

(51) Int. Cl. A23C 9/137; A23L 1/20; A23C 9/12; A23C 11/10; A23L 1/053

(52) U.S. Cl. 426/34; 426/46; 426/580; 426/634

(57) ABSTRACT

Acacia gum, in particular from Senegal acacia, is used in the preparation of a stable fermented product containing milk or soybean, wherein the gum is used in a concentration of approximately 3 to 10 wt % relative to the total weight of the fermented product containing the acacia gum, and is added after fermentation of the product.

### FIELD OF THE INVENTION

The present invention relates to fermented products containing dietary fibers and to methods for preparing the same.

### DISCUSSION OF THE PRIOR ART

Dietary fibers are plant-derived substances which are non digestible (resistant to digestive enzymes in man) and essential for the intestinal transit to function properly. These substances are divided into two categories based on their solubility in water. Soluble fibers include pectin, gums and mucilage whereas insoluble fibers are especially cellulose, hemicellulose and lignin.

Acacia gum is a natural soluble dietary fiber. This is a high molecular weight branched polysaccharide (over 100000 Da) and is compact in structure (low hydrodynamic volume).

Acacia gum, also known as gum arabic is an acacia exudate which is only purified by a physical process well known to the man skilled in the art, including such steps as grinding, dissolving in water, filtering, centrifuging, microfiltering followed by spray-drying or granulation.

There are two types of acacia gums viz acacia seyal and acacia senegal. They have slightly different structures. Nevertheless, these gums can be distinguished by their highly variable rotatory power as well as by their basic sugar composition (46% of arabinose in acacia seyal gum and 24% in acacia senegal gum).

Acacia gum, in addition to its use as a source of fiber, is commonly used in the food and agriculture industries as a stabilizing agent or as a viscosity enhancing agent: it can thus be found especially in some candies and drinks.

It is quite relevant to note that acacia gum has a fairly compact branched structure whereby viscosity development is much less important than for linear chain fibers such as pectin or guar.

In western countries, daily consumption of dietary fibers is insufficient. Average daily consumption ranges from 10 to 15 g while recommended diet intake levels are 25 to 30 g.

To backup this point, numerous epidemiological reports and more recently clinical data have demonstrated the paramount need of dietary fibers for the digestive system to function properly and the role of such fibers in preventing a great number of chronic disorders, including diabetes, cardiovascular disease, obesity and certain forms of cancer (Macfarlane S. et coll.; Aliment Pharmacol Ther, 2006, 24: 701-714 or Cherbut C.; 2003, Cahiers de nutrition et de diététique, 38: 346-354 or Cummings J H. et coll.; 2002, British Journal of Nutrition, Suppl. 2, 87: S145-S151).

Incorporating fibers into food products consumed on a daily basis is a good means to increase fiber consumption.

In production of a milk-based or soya-based fermented product containing fibers, fiber incorporation into the product at a certain level is hindered on one hand by a viscosity problem related to the viscosity enhancing properties of fibers and on the other by the incompatibility of certains soluble fibers (polysaccharides) with milk protein (casein derivatives, lactoserum protein) or soya protein which consequently disturb lactic gel formation leading to separation of the layer containing protein from the one containing gum finally resulting into a non marketable product.

U.S. Pat. No. 4,971,810 deals with a process for producing yoghurt including gum arabic as a fiber source (2 g to 6 g of fibers for 226.8 g of final product).

The method of incorporating fibers into the dairy composition is a standard method used in industry, especially to incorporate starch and gelatin, wherein the gum and milk are blended together prior to the fermentation step.

This method does not solve the technical difficulty related to incompatibility of fibers with milk protein since the fiber content is so restricted that incorporating fibers into the dairy product is compromised neither by complications at the technical level nor by organoleptic considerations.

Patent application EP 1 532 864 deals with a lean dairy product of the low fat butter or low fat margarine type, containing gum arabic.

Products being targeted are low fat products having a macroscopic structure typical of an emulsion. This structure is very different from the macroscopic structure of fermented dairy products which is colloidal solution by nature.

So far, the prior art does not provide a satisfactory solution to the problem of incorporating fibers into a milk-based or soya-based composition, more specifically to the problem of incompatibility of fibers with milk protein or soya protein.

### SUMMARY OF THE INVENTION

One primary object of the invention is to provide fermented products containing dietary fibers and having acceptable organoleptic properties (texture, viscosity, taste).

The invention is also aimed at providing a novel fermented product containing dietary fibers and having a prebiotic effect.

A further object of the invention is to provide preparation processes to obtain the products mentioned above.

The instant invention is directed to the use of acacia gum, in particular acacia senegal, for preparing a stable milk-based or soya-based fermented product with said gum being used at a concentration ranging from about 3 to about 10% by weight, in particular from about 5 to about 9% by weight, based on total weight of the fermented product containing the acacia gum and being added subsequent to fermentation of said product.

### DISCUSSION

By <<milk-based fermented product>> reference is made to a product essentially made up of milk, which may optionally contain soya, and having undergone a fermentation step. The designation <<fermented milk>> (Act N° 88-1203 dated Dec. 30, 1988) is given to a dairy product prepared from skimmed or full fat milk, or else concentrated or powdered milk, having undergone a heat treatment at least equivalent to a pasteurization treatment, and inoculated with lactic acid producing micro-organisms such as lactobacilli (Lactobacillus acidophilus, Lb. casei, Lb. plantarum, Lb. reuteri, Lb. johnsonil), certains streptococci (Streptococcus thermophilus) bifidobacteria (Bifidobacterium bifidum, B. longum, B. breve, B. animalis) and lactococci (Lactococcus lactis). The expression <<having milk as a major constituent>> stands for a product having a milk content at least equal to 50%, in particular a milk content of 70 to 100%.

By <<soya-based fermented product>>, reference is made to a product having soya as a major constituent, which may optionally contain milk, and having undergone a fementation step. The expression <<having soya as a major constituent>> stands for a product having a soya content at least equal to 50%, in particular a soya content of 70 to 100%.

By <<acacia senegal gum>>, reference is made to a gum produced from natural exudates or else triggered by incision of tree stems and branches pertaining to the genera Acacia senegal.

Acacia senegal gum is a gum of choice. By virtue of its low viscosity, it can be used at high concentrations.

Surprisingly, it has been found that the use of acacia senegal gum according to the invention allows a stable good quality product to be obtained on organoleptic grounds.

The term <<stable>> is understood to mean a product the integrity of which is preserved for at least 28 days at 10° C., that is to say the product does not display any syneresis.

Products according to the invention are stable when stored for 28 days at 10° C., do not exhibit any detectable adverse taste as judged by a standard sensory analysis test.

This analysis was run by a 6 member small panel. Consumers making up the panel were selected for their sensory capacities and did not receive prior training. A standard stirred yoghurt was used as a control.

Panel members use a taste evaluation grid whereby qualitative observations are individually noted on the following items: visual aspect of the yoghurt, texture in spoon serving, texture related mouthfeel, flavours and aroma.

A discussion is next conducted to come to a consensus between panel members for each product being tested.

As a result of this analysis, a product is deemed having <<acceptable organoleptic characteristics>> if panel members did not detect an earth-like or dust-like adverse taste in such a product.

Comparative trials performed with the very common acacia gum (Acacia seyal) under the same conditions as the present invention, have shown that products obtained have a readily identifiable adverse taste as described by panel members and furthermore are not stable; show development of a liquid exudate layer in the bottom of the pot container shortly before the expiry date, along with separation of the layer containing protein from the one containing the gum.

In the present invention, if acacia gum is used at a concentration lower than 3% by weight, based on total weight of the fermented product containing acacia gum, the product obtained does not provide an adequate dietary fiber source to comply with recommended nutritional values and in order to exert a prebiotic effect which can be measured in terms of total daily intake. The term <<prebiotic effect>> is understood to mean the effect of fibers on growth and/or activity of certain preestablished bacteria in the colon resulting in a favourable effect on the consumer's health.

Where the acacia senegal gum is used at a concentration in excess of 10% by weight, based on total weight of the fermented product containing the acacia gum, the product generally shows syneresis and an adverse taste.

It must be stressed that the acacia gum concentration used according to the invention specifically applies to the acacia gum added in the course of product preparation. The concentration level in question does not take into effect the possible presence of natural fibers contained into fruits added during preparation of product with fruits of the stirred product type with fruits nor does it take into account fibers present into soya.

The invention is also directed to a milk-based or soya-based stable fermented product which may be obtained using the process of the invention, containing acacia gum, especially acacia senegal, at a concentration ranging from about 3 to about 10%, in particular from about 5 to about 9% by weight, based on total weight of the fermented product containing the acacia gum.

In particular, said product if packaged into 125 g capacity pot containers contains about 6 g to about 12 g of acacia gum per packaging unit, which represents from 20 to 50% of the daily recommended intake of fibers. A prebiotic effect will thus be achieved for doses over 10 g of acacia gum.

According to an advantageous embodiment, the invention relates to a milk-based or soya-based stable fermented product, which may be obtained using the process of the invention containing acacia gum, especially acacia senegal, as defined hereinabove, featured in the form of a stirred fermented milk-based product or a stirred fruit product or a stirred yoghurt drink or a low fat stirred product or a milk-based fermented product containing soya or still a soya-based fermented product.

The term <<milk-based fermented product containing soya>> is understood to mean a product primarily made up of milk and also containing soya, and having undergone a fermentation step.

Conveniently, the product as defined hereinabove has a viscosity lower than 2000 mPa·s, more particularly lower than 1500 mPa·s, still more particularly lower than 600 mPa·s, said viscosity being especially measured at a temperature of 10° C. and a shear rate of 64 s⁻¹.

The viscosity was measured using a Rheomat 180 model viscosimeter from Rheometric Scientific Corp.

When a stirred fermented milk product drink is specifically contemplated pursuant to the invention, viscosity is comprised between 150 and 200 mPa·s.

Comparative measures of viscosity were conducted 15 days later on a control product (stirred Activia type plain yoghurt) and a test-product (containing 8% of acacia senegal gum). Viscosity measurements were respectively 620 mPa·s and 610 mPa·s.

Products according to the invention containing acacia senegal gum have a viscosity close to that of standard products currently available on the market.

Comparative tests conducted with 6% hydrolyzed guar gum by operating in the same conditions as the present invention, resulted into stirred products perceived as having a too thick and sticky mouthfeel, and hence unacceptable on the organoleptic level. Viscosity was found to be in this case about 1500 mPa·s.

It must be stressed that viscosity measurement does not allow full assessment of texture related mouthfeel for a given product. Such an assessment of texture (thickness, sticky mouthfeel . . . ) is made by a panel of experts on sensory analysis who are familiar with the product type under consideration. Assessment of this kind is well known to the skilled man in the art.

According to an advantageous embodiment, the product as defined hereinabove is such that the fat content ranges from about 0 to about 8%, in particular from about 3 to about 5%, especially being about 3.2% by weight, based on total weight of the fermented product containing the acacia gum.

The term fat (MG—matières grasses) is understood to mean fatty substances (fats, oils) contained in food. The fat content is measured based on the weight of the final product.

According to a further advantageous mode of practice, the product as defined above is such that the level of liquid layer exudate is less than about 5%, more particularly less than about 3%, still more particularly less than about 1%, based on total weight of the product.

The expression <<liquid layer exudate>> is understood to mean the clear layer developing at the bottom of the pot container shortly before the use-by date after keeping the product in storage for 20 to 25 days.

The expression level of separated liquid layer stands for the quantity of liquid present upon reaching the use-by date (DLC—date limite de consommation) at the bottom of the pot container.

This <<level of liquid layer exudate>> is very easily measured by the skilled man in the art by using for example, a transparent recipient and by measuring the height of the clear layer developing at the bottom of the pot container in the course of storage of this product and by dividing this value by the total height of the product.

A product having a level of liquid layer exudate less than 5% is considered to be a stable product since there is virtually no syneresis.
The invention also deals with a process for preparing a milk-based or soya-based stable fermented product, containing acacia gum, especially acacia senegal, said process comprising a step of incorporating within a milk-based or soya-based fermented product, from about 10 to about 30% by weight of a concentrated aqueous solution of acacia senegal gum, based on total weight of the fermented product containing the acacia gum, said concentrated aqueous solution of acacia senegal gum containing from about 30 to about 50% of acacia gum based on the total weight of the solution;
said milk-based or soya-based fermented product being obtained through fermenting a milk-based or soya-based initial product, said milk-based or soya-based initial product being seeded beforehand with a starter culture. It has surprisingly been found that incorporation of acacia gum, subsequent to fermentation can totally resolve the incompatibility issue between fibers and milk protein or soya protein thus obtaining a homogenous stable product.

The expression <<milk-based initial product>> stands for a dairy product used as starting material for seeding with a starter culture. Generally, when producing a milk-based fermented product, the milk-based initial product is standardized beforehand in terms of fat content, enriched with protein, homogenized and subsequently subjected to a heat treatment.

The expression <<soya-based initial product>> stands for a soya-based starting product which did not undergo fermentation.

Another advantage resulting from incorporating acacia gum subsequent to fermentation is to provide dairy industries with one single starting white mass mix from which different products can be obtained by adding different preparations.

According to one advantageous embodiment, the process as defined above includes an additional step of incorporating a portion of the acacia senegal gum in powder form into the milk-based or soya-based initial product, such an incorporation step being carried out prior to fermentation, the portion of acacia gum incorporated prior to fermentation accounting at most 1.5% of the total weight of the fermented product containing the acacia gum.

Acacia senegal gum in powder form may be the ingredient Fibergum B (CNI Corp.)

It has been demonstrated that incorporation of gum prior to fermentation in quantities over 1.5% of the total weight of the fermented product inevitably leads to the formation of bad quality lactic gel due to incompatibility between the gum and milk protein. By this process of direct incorporation, the maximum quantity of acacia gum that could possibly be incorporated into a 125 g pot container is 1.75 g.

A bad quality lactic gel is characterized by aggregation of milk protein followed by segregation of protein and fiber and finally by development of macroscopic syneresis into the product.

Conveniently, in the process as defined above, the concentrated aqueous solution of acacia senegal gum has content of acacia senegal gum from about 30 to about 50%, more particularly from about 40 to about 50% and still more particularly from about 42 to about 47% and even still more particularly about 45% based on total weight of said concentrated aqueous solution mentioned above.

In particular, the concentrated aqueous solution of acacia senegal gum has a viscosity of 2300 mPa·s. at 20° C.

According to one advantageous embodiment, in the process as defined above, the concentrated aqueous solution of acacia senegal gum is prepared by mixing acacia gum into an aqueous medium, especially selected among water, fruit juice, plant juice, followed by a treatment intended to remove bacterial contaminants, especially a heat treatment at about 95° C. for 5 to 10 minutes.

Mixing of the aqueous medium with the acacia gum is performed using a static or dynamic mixer.

According to one further advantageous embodiment, the process as defined above, comprises
a preparation step of a milk-based or soya-based fermented product, obtained by fermentation of a milk-based or soya-based initial product, said milk-based or soya-based initial product being seeded beforehand with a starter culture,
an incorporation step, into the milk-based or soya-based fermented product previously obtained, of 10 to 30% by weight of a concentrated aqueous solution of acacia senegal gum, based on total weight of fermented product containing the acacia gum;

said concentrated aqueous solution of acacia senegal gum containing from about 30 to about 50% of acacia gum based on total weight of the solution and being obtained by mixing acacia gum into an aqueous medium, especially selected among water, fruit juice, plant juice, followed by a treatment intended to remove bacterial contaminants, especially a heat treatment, of said concentrated aqueous solution.

The incorporation step of the concentrated aqueous solution of acacia senegal gum into the milk-based or soya-based fermented product is done using a static or dynamic mixer.

According to one further advantageous embodiment, the process of the invention as defined above comprises:
a preparation step of a concentrated aqueous solution of acacia senegal gum by mixing acacia gum into an aqueous medium, especially selected among water, fruit juice, plant juice, followed by a heat treatment of said concentrated aqueous solution by heating at about 95° C. for 5 to 10 minutes, said solution having a content of acacia senegal gum of about 30 to about 50%, more particularly of about 40 to about 50%, and especially of about 42 to about 47%, and still more particularly of about 45% based on total weight of said concentrated aqueous solution mentioned above,
a preparation step of a milk-based or soya-based fermented product, obtained through fermentation of a milk-based or soya-based initial product, said milk-based or soya-based initial product, being seeded beforehand by a starter culture, especially composed of one or more strains of Streptococcus spp., of Lactobacillus spp., especially L. bulgaricus, L. acidophilus, L. reuteri, L. plantarum and L. casei, of Lactococcus spp., preferably L. lactis subsp. cremoris and of Bifidobacterium spp., preferably B. animalis ssp lactis, B. longum and B. breve;

the order of these respective preparation steps of the concentrated aqueous solution of acacia gum and of preparation of the milk-based or soya-based fermented product, being irrelevant, and
an incorporation step into the previously obtained milk-based or soya-based fermented product, of 10 to 30% by weight of said concentrated aqueous solution of acacia senegal gum, based on total weight of the fermented product containing the acacia gum.

According to one further embodiment, the process of the invention as defined above comprises:
a preparation step of a concentrated aqueous solution of acacia senegal gum by mixing acacia gum into an aqueous medium, especially selected among water, fruit juice, plant juice, followed by a heat treatment of said concentrated aqueous solution by heating at about 95° C. for 5 to 10 minutes, said solution having a content of acacia senegal gum of about 30 to about 50%, more particularly of about 40 to about 50%, and especially of about 42 to about 47%, and still more particularly of about 45% based on total weight of said concentrated aqueous solution mentioned above,
a preparation step of a milk-based or soya-based non fermented product containing acacia gum, through incorporation of a portion of the acacia senegal gum in powder form into a milk-based or soya-based initial product; such an incorporation step being carried out prior to fermentation of said previously mentioned initial product, the portion of acacia gum incorporated prior to fermentation accounting at most for 1.5% of the total weight of the fermented product containing the acacia gum;
a fermentation step of the product obtained through the previous step, and
an incorporation step into the previously obtained milk-based or soya-based fermented product, of 10 to 30% by weight of said concentrated aqueous solution of acacia senegal gum, based on total weight of the fermented product containing acacia gum.

The invention is also directed to a milk-based or soya-based fermented product containing acacia gum, as obtained through practice of the process as defined above.

The invention also deals with a milk-based or soya-based stable fermented product containing acacia gum, as obtained by a preparation process comprising:
a preparation step of a milk-based or soya-based fermented product, obtained by fermentation of a milk-based or soya-based initial product, said milk-based or soya-based initial product being seeded beforehand with a starter culture,
an incorporation step, into the previously obtained milk-based or soya-based fermented product, of 10 to 30% by weight of a concentrated aqueous solution of acacia senegal gum, based on total weight of the fermented product containing the acacia gum;
   said concentrated aqueous solution of acacia senegal gum containing from about 30 to about 50% of acacia gum based on total weight of the solution and being obtained by mixing acacia gum into an aqueous medium, especially selected among water, fruit juice, plant juice, followed by a treatment intended to remove bacterial contaminants, especially a heat treatment, of said concentrated aqueous solution.

### EXAMPLES

### Example 1

### A Process for Preparing a Milk-Based Stable Stirred Fermented Product Containing Acacia senegal Gum

1) Milk Preparation

Skimmed or partially skimmed milk (1.5% fat content (MG)), cream (40% fat content), powdered skimmed milk (30% protein content) and optionally sugar are mixed in order to standardize the milk protein and fat content. The product will be formulated so as to obtain a protein content of 4.5%.

2) Heat Treatment & Homogenization

Milk is then heated at a temperature between 85° C. and 90° C. for 15 to 30 minutes in order to destroy pathogenic microorganisms possibly present and to improve the physical properties of the yoghurt. Once the required temperature is reached, a homogenization treatment is carried out in order to disrupt fat droplets by systems well known to the skilled man in the art and under pressure of 100 to 300 bars.

3) Cooling

Next, cooling of the milk, typically down to about 40° C., is done. The milk once cooled down to fermentation temperature is then transferred into a tank.

4) Seeding

The milk is seeded by inoculation with a starter culture (S. thermophilus and L. bulgaricus in a quantity of 0.001 to 0.5 g/L) at a fermentation temperature comprised between 36° C. and 45° C. and an acid treatment is monitored until a pH ranging from 4.6 to 4.7 is reached. The fermentation reaction is stopped upon reaching the target pH. As a result of such fermentation, a (curdled milk) lactic gel is then formed.

5) Uncurdling and Smoothing

Uncurdling is done by blending the lactic gel through pumping of the gel. This uncurdling step is optionally followed by a smoothing step (running the gel through a filter)

6) Mixing with a Concentrated Aqueous Solution of Acacia Gum

In a first step, a concentrated aqueous solution of acacia gum is prepared by mixing under stirring 45% of acacia gum into 55% of aqueous medium, especially selected among water, fruit juice, plant juice. Next, a heat treatment of the solution is performed by heating at about 95° C. for 5 to 10 minutes.

Next, 20% of the concentrated aqueous solution of acacia senegal gum are incorporated into 80% of a fermented milk product as previously obtained (through steps 1 to 5) with the aid of a static or dynamic mixer.

7) Packaging

Packaging is done by pouring into 125 g pot containers. Products are stored in a cold room at 10° C.

After storage for 28 days, these products do not show any syneresis, nor any adverse taste upon conducting a standard sensory analysis.

### Example 2

### A Process for Preparing a Milk-Based Stable Fruit Stirred Fermented Product Containing Acacia senegal Gum

The process for preparing such a product requires the first 5 steps of the process described in Example 1.

Step 6 is similar to mixing a concentrated aqueous solution of acacia senegal gum prepared as in Example 1 with a fruit preparation (containing 50% of fruit chunks) and subsequently incorporating such a composition into the fermented milk product previously obtained through steps 1 to 5 of the process depicted in Example 1.

After storage for 28 days, these products do not show any syneresis nor any detectable adverse taste as determined by a standard sensory analysis.

### Example 3

### A Process for Preparing a Milk-Based or Soya-Based Stable Stirred Fermented Drink Product Containing Acacia senegal Gum

The process for preparing a stirred fermented milk drink product containing acacia senegal gum is similar to the process described in Example 1, except for the following differences:
a protein content of 3%
more extensive smoothing and
a homogenization treatment at step 3).

After storage for 28 days, these products do not show any syneresis nor any detectable adverse taste as determined by a standard sensory analysis.

### Example 4

### A Process for Preparing a Stable Low Fat (0% Fat Content) Stirred Milk-Based Fermented Product Containing Acacia senegal Gum

The process for preparing a stable low fat stirred milk-based fermented product starts with a preparation step of milk by mixing skimmed milk with powdered skimmed milk.

The following preparation steps (steps 2 to 7) are identical to those reported in Example 1.

After storage for 28 days, these products do not show any syneresis nor any detectable adverse taste as determined by a standard sensory analysis.

### Example 5

### A Process for Preparing a Stable Soya-Based Fermented Product Containing Acacia senegal Gum

The first step of this process consists in mixing soya milk (90%) with starch and sugar as optional ingredients.

The following preparation steps (steps 2 to 7) are identical to those depicted in Example 1.

After storage for 28 days, these products do not show any layer separation nor any detectable adverse taste as determined by a standard sensory analysis.

### Example 6

### A Process for Preparing a Stable Milk-Based Fermented Product Containing Soya and Acacia senegal Gum

The first step of this process consists in mixing skimmed milk or partially skimmed milk (1.5% fat content (MG)), cream (40% fat content (MG)) and powdered skimmed milk (30% protein content) and purified soya protein (the production process of which is well known to the skilled man in the art) and optionally sugar.

The following preparation steps (steps 2 to 7) are identical to those depicted in Example 1.

After storage for 28 days, these products do not show any syneresis nor any detectable adverse taste as determined by a standard sensory analysis.

### Example 7

### Comparative Test: A Process for Preparing Fermented Milk Products Containing Acacia senegal Gum Added Before Fermentation

Preparation of fermented milk products containing 1.5%, 2%, 3% & 5% of acacia gum

Formulation

TABLE I
Composition of the white mass mix

| | | | Portion of added |
|---|---|---|---|
| Protein content (%) | Fats (%) | Carbohydrates (%) | sugars (%) |
| 4.2 | 3.9 | 11.1 | 4.8 |

Five products were prepared:
Control without acacia
white mass mix containing 1.5% of acacia gum by weight, based on total of the product
white mass mix containing 2.0% of acacia gum by weight, based on total of the product
white mass mix containing 3.0% of acacia gum by weight, based on total weight of the product
white mass mix containing 5.0% of acacia gum by weight, based on total weight of the product

The acacia gum used is the ingredient FIBERGUM P (supplier: CNI)

Process:

Powdering: Powders were suspended at room temperature (Skimmed milk powder PLE—poudre de lait écrémé, sugar and acacia gum) into a stirred tank containing cream and 0% fat milk.

Heat treatment: The guidelines for heat treatment being followed is a standard guideline for processing stirred yoghurt products (95° C. for 6 minutes)

Fermentation: The starter culture used is a symbiotic combination of Streptococcus lactobacilus and S. bifidus (at a rate of 0.1%) with a fermentation time period of 7½ hours until an uncurdling pH of 4.7 is reached. The fermentation medium temperature is 37° C. Acacia gum has no noticeable impact on fermentation time.

Uncurdling—Cooling: Uncurdling is performed within the tank under stirring and the products undergo next a smoothing treatment across a 500 μm filter during cooling.

Follow-up of products over time:

Viscosity assessment of all 5 products was done using a viscosimeter apparatus having the following specifications:
Material used: MCR 300 (Anton Paar)
Geometry: ME-21
Temperature: 10° C.
Software: US200/32 V2.43 (Physica)

Results are recorded in the following table:

TABLE II
(Follow-up of the viscosity-stability of products)

Viscosity at 64 s⁻¹,
10 s (mPa · s)

| Products | D + 0 | D + 1 | D + 3 | D + 7 |
|---|---|---|---|---|
| Control | 1421 | 1438 | 1435 | 1541 |
| Acacia 1.5 | 1480 | 1617 | 1554 | 1748 |
| Acacia 2.0 | 809 | 877 | 921 | 923 |
| Acacia 3.0 | 114 | 115 | 63 | 64 |
| Acacia 5.0 | 51 | 57 | 36 | 48 |

As the quantity of acacia increases, the protein gel is less well formed and increasingly sluggish.

Upon reaching the smoothing stage, the viscosity measurements of products containing over 1.5% of acacia are low. As a matter of fact, products containing 2% of acacia have a viscosity which is 40% lower than that of the control and products containing 3% and 5% diverge by 90% and 95% respectively from control viscosity values (Table II)

Furthermore, a density gradient is visible for products containing 3% and 5% of acacia. The thicker lower layer which accounts for 38% and 15% of the total volume for products containing 3% and 5% of acacia respectively, seems to be made up by partial aggregation of protein. The proportion of the lower layer is determined by the skilled artisan in the field by computing the lower layer height to the product total height ratio.

After storage for 20 to 25 days, product decanting was performed and a liquid exudate layer level greater than 5% by weight was recorded for the product based on total weight thereof.

Conclusion

Direct addition of acacia gum by over 1.5%, prior to heat treatment disrupts smooth development of the protein network in the course of fermentation. This directly results into a very significant loss of viscosity.

Moreover, the products are not stable over time and layer separation becomes visible at D+7 for products containing 3% and 5% of acacia gum.

Addition of acacia gum in quantities over 1.5% prior to fermentation does now allow products of acceptable quality to be obtained as far as texture and stability are concerned.

By contrast, studies have shown that by adding acacia gum in quantities up to 1.5% prior to fermentation and between 3 and 10% subsequent to fermentation, the product is kept stable and displays acceptable organoleptic properties.

1-13. (canceled)

14. A method for preparing a milk-based or soya-based stable fermented product by means of acacia gum, said gum being used at a concentration ranging from 3 to 10%, by weight, based on total weight of the fermented product containing the acacia gum and being added subsequent to fermentation of said product.

15. The method according to claim 14, wherein acacia gum is acacia Senegal.

16. The method according to claim 14, wherein said gum is used at a concentration ranging from 5 to 9%.

17. A process for preparing a milk-based or soya-based stable fermented product, containing acacia gum, said process comprising a step of incorporating within a milk-based or soya-based fermented product, from 10 to 30% by weight of a concentrated aqueous solution of acacia senegal gum, based on total weight of the fermented product containing the acacia gum, said concentrated aqueous solution of acacia senegal gum containing from 30 to 50% of acacia gum based on the total weight of the solution;
said milk-based or soya-based fermented product being obtained through fermenting a milk-based or soya-based initial product, said milk-based or soya-based initial product being seeded beforehand with a starter culture.

18. The process according to claim 17, wherein acacia gum is acacia Senegal.

19. The process according to claim 18, comprising an additional step of incorporating a portion of the acacia senegal gum in powder form into the milk-based or soya-based initial product, such an incorporation step being carried out prior to fermentation, the portion of acacia gum incorporated prior to fermentation representing at most 1.5% of the total weight of the fermented product containing the acacia gum.

20. The process according to claim 18, wherein the concentrated aqueous solution of acacia senegal gum has a content of acacia senegal gum from 30 to 50%, based on total weight of said concentrated aqueous solution mentioned above.

21. The process according to claim 20, wherein the content of acacia senegal gum is from 40% to 50%.

22. The process according to claim 20, wherein the content of acacia senegal gum is from 42% to 47%.

23. The process according to claim 20, wherein the content of acacia senegal gum is 45%.

24. The process according to claim 18, wherein the concentrated aqueous solution of acacia senegal gum is prepared by mixing acacia gum into an aqueous medium, selected among water, fruit juice, plant juice, followed by a treatment intended to remove bacterial contaminants, including a heat treatment at 95° C. for 5 to 10 minutes.

25. The process for preparing a stable fermented product according to claim 18, comprising:
a preparation step of a milk-based or soya-based fermented product, obtained by fermentation of a milk-based or soya-based initial product, said milk-based or soya-based initial product being seeded beforehand with a starter culture,
an incorporation step, into the milk-based or soya-based fermented product previously obtained, of 10 to 30% by weight of a concentrated aqueous solution of acacia senegal gum, based on total weight of fermented product containing the acacia gum;
said concentrated aqueous solution of acacia senegal gum containing from 30 to 50% of acacia gum based on total weight of the solution and being obtained by mixing acacia gum into an aqueous medium selected among water, fruit juice, plant juice, followed by a treatment intended to remove bacterial contaminants, including a heat treatment, of said concentrated aqueous solution.

26. The process for preparing a stable fermented product according to claim 18, comprising:
a preparation step of a concentrated aqueous solution of acacia senegal gum by mixing acacia gum into an aqueous medium, selected among water, fruit juice, plant juice, followed by a heat treatment of said concentrated aqueous solution by heating at 95° C. for 5 to 10 minutes, said solution having a content of acacia senegal gum of 30 to 50%, based on total weight of said previous concentrated aqueous solution.
a preparation step of a milk-based or soya-based fermented product, obtained through fermentation of a milk-based or soya-based initial product, said milk-based or soya-based initial product, being seeded beforehand by a starter culture, including the one composed of one or more strains of Streptococcus spp., of Lactobacillus spp., including L. bulgaricus, L. acidophilus, L. reuteri, L. plantarum and L. casei, of Lactococcus spp., including L. lactis subsp. cremoris and of Bifidobacterium spp., including B. animalis ssp lactis, B. longum and B. breve;
the order of these respective preparation steps of the concentrated aqueous solution of acacia gum and of preparation of the milk-based or soya-based fermented product, being irrelevant, and
an incorporation step into the previously obtained milk-based or soya-based fermented product, of 10 to 30% by weight of said concentrated aqueous solution of acacia senegal gum, based on total weight of the fermented product containing the acacia gum.

27. The process according to claim 20, wherein the content of acacia senegal gum is from 40% to 50%.

28. The process according to claim 26, wherein the content of acacia senegal gum is from 42% to 47%.

29. The process according to claim 26, wherein the content of acacia senegal gum is 45%.

30. The process for preparing a stable fermented product according to claim 18, comprising:
a preparation step of a concentrated aqueous solution of acacia senegal gum by mixing acacia gum into an aqueous medium, selected among water, fruit juice, plant juice, followed by a heat treatment of said concentrated aqueous solution by heating at 95° C. for 5 to 10 minutes, said solution having a content of acacia senegal gum of 30 to 50%, based on total weight of said concentrated aqueous solution mentioned above,
a preparation step of a milk-based or soya-based non fermented product containing acacia gum, through incorporation of a portion of the acacia senegal gum in powder form into a milk-based or soya-based initial product; such an incorporation step being carried out prior to fermentation of said initial product mentioned above, the portion of acacia gum incorporated prior to fermentation accounting at most for 1.5% of the total weight of the fermented product containing the acacia gum;
a fermentation step of the product obtained through the previous step by seeding beforehand with a starter culture, and
an incorporation step into the milk-based or soya-based fermented product previously obtained of 10 to 30% by weight of said concentrated aqueous solution of acacia senegal gum, based on total weight of the fermented product containing the acacia gum.

31. The process according to claim 30, wherein the content of acacia senegal gum is from 40% to 50%.

32. The process according to claim 30, wherein the content of acacia senegal gum is from 42% to 47%.

33. The process according to claim 30, wherein the content of acacia senegal gum is 45%.

34. A stable milk-based or soya-based fermented product, which may be obtained by the process of the invention, containing acacia gum, at a concentration of 3 to 10%, by weight, based on total weight of the fermented product containing the acacia gum.

35. The product according to claim 34, wherein the acacia gum is acacia Senegal gum.

36. The product according to claim 35, wherein the concentration of acacia Senegal gum is 5 to 9% by weight.

37. A stable milk-based or soya-based fermented product, which may be obtained by the process of the invention containing acacia gum, according to claim 34, formulated in the form of a stirred fermented milk-based product or a stirred fruit product or a stirred yoghurt drink or a stirred low fat product or a milk-based fermented product containing soya or still a soya-based fermented product.

38. The product according to claim 37, wherein the accacia gum is acacia Senegal gum.

39. The product according to claim 34, having a viscosity lower than 2000 mPa·s, said viscosity being measured at a temperature of 10° C. and a shear rate of 64 s⁻¹.

40. The product according to claim 39, wherein the viscosity is lower than 1500 mPa·s.

41. The product according to claim 39, wherein the viscosity is lower than 600 mPa·s.

42. The product according to claim 34, wherein the fat content ranges from 0 to 8%, by weight, based on total weight of the fermented product containing the acacia gum.

43. The product according to claim 42, wherein the fat content range from 3 to 5% by weight.

44. The product according to claim 42, wherein the fat content range from 3.2% by weight.

45. The product according to claim 34, wherein the level of milk serum exudate layer is lower than 5%, based on total weight of the product.

46. The product according to claim 45, wherein the level of milk serum exudate layer is lower than 3%.

47. The product according to claim 45, wherein the level of milk serum exudate layer is lower than 1%.
